(19) United States
(12) Patent Application Publication
(10) Pub. No.: US 2026/0113133 A1
(43) Pub. Date: Apr. 23, 2026

(54) METHOD FOR REDUCING INTERFERENCE COMPONENTS USING GUIDED SYMBOLS

(71) Applicant: ELECTRONICS AND TELECOMMUNICATIONS RESEARCH INSTITUTE, Daejeon (KR)

(72) Inventors: Chung Sup KIM, Daejeon (KR); JUNSEOK KIM, Daejeon (KR); Hyuk Je KIM, Daejeon (KR); Kwanwoong RYU, Daejeon (KR); Sung Woong CHOI, Daejeon (KR)

(73) Assignee: ELECTRONICS AND TELECOMMUNICATIONS RESEARCH INSTITUTE, Daejeon (KR)

(21) Appl. No.: 19/363,980

(22) Filed: Oct. 21, 2025

(30) Foreign Application Priority Data
Oct. 23, 2024 (KR) 10-2024-0146029

(51) Int. Cl. H04B 17/309; H04B 17/318; H04B 17/345

(52) U.S. Cl. CPC H04B 17/346; H04B 17/318; H04B 17/345

(57) ABSTRACT

An operating method of a user equipment in communication with a base station is provided. The operating method has receiving a first frame signal, determining, based on the first frame signal, whether an intensity value of a first interference component exceeds a threshold value, emitting an interference response signal, receiving a second frame signal including a second symbol including a second signal component and a first guided symbol including a second interference component, generating a first signal reduction information that cancels the second interference component, receiving a third frame signal including a third symbol in which a third interference component corresponding to the first interference component and a third signal component are mixed, and obtaining the third signal component by reducing the third interference component of the third symbol based on the first signal reduction information.

### CROSS-REFERENCE TO RELATED APPLICATIONS

This application claims priority under 35 U.S.C. § 119 to Korean Patent Application No. 10-2024-0146029 filed on Oct. 23, 2024, in the Korean Intellectual Property Office, the disclosure of which is incorporated by reference herein in their entirety.

### BACKGROUND

The present disclosure relates to a method for reducing an interference component, and more particularly, to a method of reducing an interference component using a guided symbol.

The communication system may include a base station and a user equipment. The base station may emit a frame signal including a signal component to be transmitted.

The frame signal emitted by the base station may be mixed with an interference component in a process of reaching the user equipment. In order to increase the transmission efficiency of a communication system, a method for efficiently reducing the interference component is required.

### SUMMARY

According to an embodiment of the present disclosure, there is provided an interference component reduction method using a guided component.

According to an embodiment of the present disclosure, a method of operating a user equipment in communication with a base station comprises receiving, from the base station, a first frame signal including a first symbol in which a first interference component generated based on a first surrounding environment and a first signal component are mixed, determining, based on the first frame signal, whether an intensity value of the first interference component exceeds a threshold value, emitting, in response to determining that the intensity value of the first interference component exceeds the threshold value, an interference response signal, receiving, after emitting the interference response signal, a second frame signal from the base station, the second frame signal including a second symbol including a second signal component and a first guided symbol including a second interference component corresponding to the first interference component, wherein the first guided symbol is independent of the second signal component, generating a first signal reduction information that cancels the second interference component based on the first guided symbol, receiving, from the base station, a third frame signal including a third symbol in which a third interference component corresponding to the first interference component and a third signal component are mixed, and obtaining the third signal component by reducing the third interference component of the third symbol based on the first signal reduction information.

According to an embodiment of the present disclosure, the method further comprises determining a noise level of the third signal component, and determining whether the noise level exceeds a noise threshold value.

According to an embodiment of the present disclosure, the method further comprises reducing, in response to determining that the noise level does not exceed the noise threshold value, an interference component based on the first surrounding environment based on the first signal reduction information.

According to an embodiment of the present disclosure, the method further comprises determining, in response to determining that the noise level exceeds the noise threshold, whether the noise level is based on a second surrounding environment different from the first surrounding environment or based on a disappearance of the first surrounding environment.

According to an embodiment of the present disclosure, the method further comprises receiving, in response to determining that the noise level is based on the second surrounding environment, a frame signal including a second guided symbol from the base station, generating, based on the second guided symbol, a second signal reduction information that cancels an interference component based on the second surrounding environment, and reducing, based on the second signal reduction information, the interference component based on the second surrounding environment.

According to an embodiment of the present disclosure, the method further comprises obtaining, in response to determining that the noise level is based on the disappearance of the first surrounding environment, a signal component independently of the first signal reduction information.

According to an embodiment of the present disclosure, the base station and the user equipment store the same reference symbol, the first frame signal further includes the reference symbol, and determining, based on the first frame signal, whether an intensity value of the first interference component exceeds a threshold value further includes determining, based on a comparison operation of the first frame signal and the reference symbol stored in the user equipment, an intensity value of a first interference component.

According to an embodiment of the present disclosure, the second frame signal includes a subframe signal, and the subframe signal sequentially includes first to first symbols and the first guided symbol.

According to an embodiment of the present disclosure, generating the first signal reduction information that cancels the second interference component based on the first guided symbol further comprises generating, based on the first guided symbol, interference correlation data in a matrix format consisting of N rows and N columns, where N is any natural number, generating, based on the interference correlation matrix data, first to N-th eigenvectors and first to N-th eigenvalues respectively corresponding to the first to N-th eigenvectors, determining, based on the first to N-th eigenvectors and the first to N-th eigenvalues, first to M-th dominant eigenvectors further including information of the second interference component and a first to M-th dominant eigenvalues respectively corresponding to the first to M-th dominant eigenvectors, wherein M is any natural number less than or equal to N, generating first to L-th reduction vectors orthogonal to all of the first to M-th dominant eigenvectors, wherein L is any natural number, and generating, based on the first to L-th reduction vectors, the first signal reduction information in a matrix data format.

According to an embodiment of the present disclosure, a user equipment in communication with a base station, comprises an interference signal sensing apparatus configured to receive, from the base station, a first frame signal including a first symbol in which a first interference component generated based on a first surrounding environment and a first signal component are mixed, determine, based on the first frame signal, whether an intensity value of the first interference component exceeds a threshold value, and emit an interference response signal in response to determining that the intensity value of the first interference component exceeds the threshold value, an interference signal analysis apparatus configured to receive, from the base station after radiating the interference response signal, a second frame signal including a second symbol including a second signal component and a first guided symbol independent of the second signal component and including a second interference component corresponding to the first interference component, and generate first signal reduction information that cancels the second interference component based on the first guided symbol, and an interference signal reduction apparatus configured to receive, from the base station, a third frame signal including a third symbol in which a third interference component corresponding to the first interference component and a third signal component are mixed, and obtain the third signal component by reducing the third interference component of the third symbol based on the first signal reduction information.

According to an embodiment of the present disclosure, the interference signal sensing apparatus further configured to determine, based on the third signal component with the third interference component reduced, a noise level of the third signal component.

According to an embodiment of the present disclosure, the interference signal sensing apparatus further configured to determine whether the noise level of the third signal component exceeds a noise threshold value, and determine, in response to determining that the noise level exceeds the noise threshold value, whether the noise levels are based on a second surrounding environment different from the first surrounding environment or based on the disappearance of the first surrounding environment.

According to an embodiment of the present disclosure, the interference signal analysis apparatus further configured to receive, in response to determining that the noise level is based on the second surrounding environment, a frame signal including a second guided symbol from the base station, and generate, based on the second guided symbol, second signal reduction information that cancels an interference component based on the second surrounding environment.

According to an embodiment of the present disclosure, the second frame signal includes a subframe signal, and the subframe signal sequentially includes first to first symbols and the first guided symbol.

### BRIEF DESCRIPTION OF DRAWINGS

The above and other objects and features will be more apparent from the following description of embodiments, taken in conjunction with the accompanying drawings, in which:

FIG. 1 is a diagram illustrating a communication system according to an embodiment of the present disclosure.

FIG. 2 is a diagram illustrating a configuration of a frame signal according to some embodiments of the present disclosure.

FIG. 3 is a diagram illustrating a configuration of a frame signal according to some embodiments of the present disclosure.

FIG. 4 is a flowchart illustrating an interference component reduction method according to some embodiments of the present disclosure.

FIG. 5 is a flowchart illustrating a method of operating a base station and a user equipment according to some embodiments of the present disclosure.

FIG. 6 is a flowchart illustrating a method of operating a base station and a user equipment according to some embodiments of the present disclosure.

FIG. 7 is a diagram illustrating steps of obtaining signal reduction information according to some embodiments of the present disclosure.

FIG. 8 is a graph illustrating an effect of an interference component reduction method according to some embodiments of the present disclosure.

FIG. 9 is a graph illustrating an interference component reduction method according to some embodiments of the present disclosure.

### DETAILED DESCRIPTION

Below, embodiments of the present disclosure will be described in detail and clearly to such an extent that an ordinary one in the art easily carries out the present disclosure.

As used herein, including in the claims, “or” as used in a list of items (e.g., a list of items prefaced by a phased such as “at least one of” or “one or more of” or “one or both of” indicates as inclusive list such that, for example, a list of at least one of A, B, or C means A or B or C or AB or AC or BC or ABC (i.e., A and B and C).

Terms such as “unit” and “module” used below or the functional blocks shown in the drawings may be implemented in the form of a software configuration, a hardware configuration, or a combination thereof. In the following, in order to clearly explain the technical idea of the present invention, detailed descriptions of redundant components are omitted.

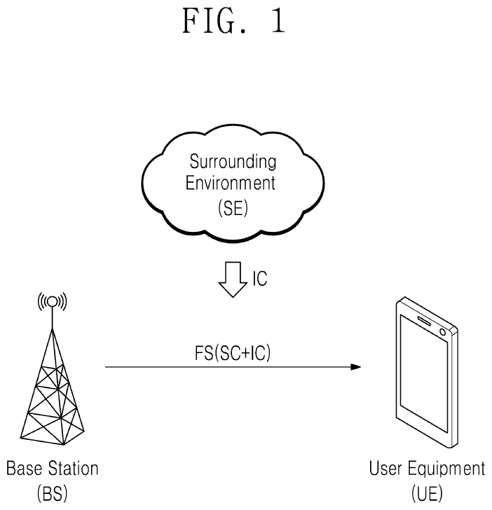

FIG. 1 is a diagram illustrating a communication system according to an embodiment of the present disclosure. Referring to FIG. 1, a communication system may include a base station BS and a user equipment UE.

The base station BS may provide a frame signal FS to the user equipment UE. The frame signal FS may include a signal component SC to be transmitted by the base station BS. In a process in which the frame signal FS is provided to the user equipment UE, an interference component IC generated in a surrounding environment SE may be mixed with the frame signal FS.

The user equipment UE receives the frame signal FS including the signal component SC and the interference component IC. According to an embodiment of the present disclosure, there is provided a method of reducing an interference component IC in order to obtain a signal component SC to be transmitted by a base station BS in a user equipment UE.

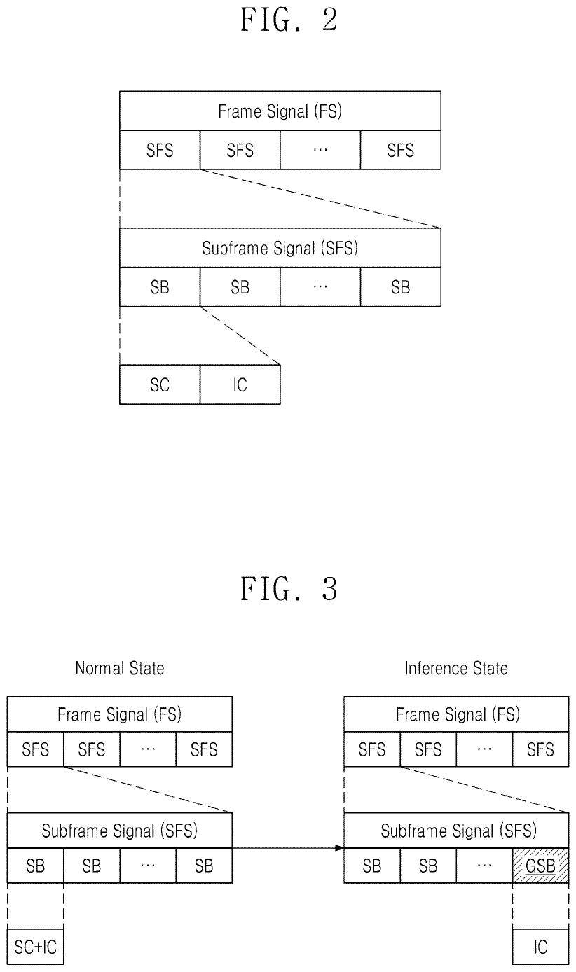

FIG. 2 is a diagram illustrating a configuration of a frame signal according to some embodiments of the present disclosure. Referring to FIG. 2, the frame signal FS may include a plurality of subframe signals SFS.

The subframe signal SFS may include a plurality of symbols SB. The symbol SB may be a mixture of a signal component SC and an interference component IC. The signal component SC may include information to be transmitted from the base station BS to the user equipment UE. The interference component IC may be generated in the surrounding environment SE.

In some embodiments, a time interval length of the frame signal FS may be 10 ms, and the time interval length of a subframe signal SFS may be one of 1 ms, 0.5 ms, or 0.25 ms.

FIG. 3 is a diagram illustrating a configuration of a frame signal according to some embodiments of the present disclosure. Referring to FIG. 3, a subframe signal SFS included in the frame signal FS corresponding to the interference state may include a guided symbol GSB.

The frame signal FS corresponding to the normal state may include a plurality of subframe signals SFS, and each subframe signal SFS may include a plurality of symbols SB.

The symbol SB included in the subframe signal SFS corresponding to the normal state may be a mixture of the signal component SC and the interference component IC.

The frame signal FS corresponding to the interference state may include a plurality of subframe signals SFS, and at least one subframe signal SFS among the plurality of subframes signals SFS may include a guided symbol GSB. The guided symbol GSB may be composed of the interference component IC. The guided symbol GSB may be independent of the signal component SC.

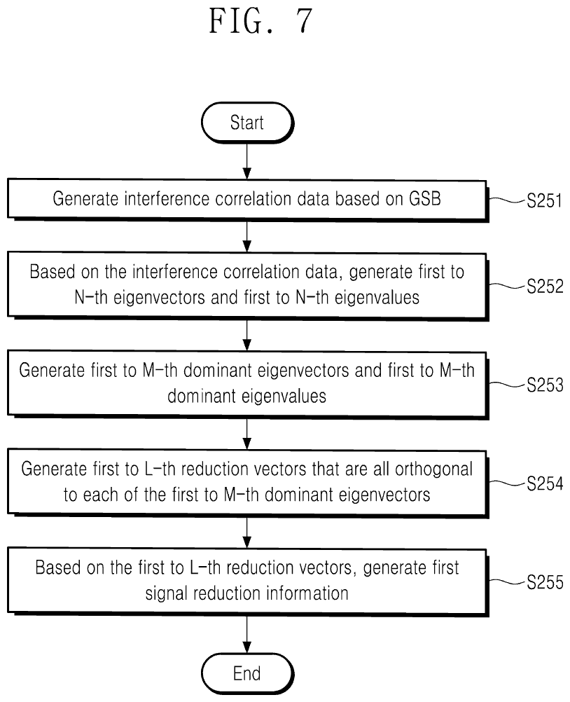

Based on the guided symbol GSB, the user equipment UE may generate signal reduction information that cancels out the interference component IC. A more detailed description of the signal reduction information generation will be described below with reference to FIG. 7.

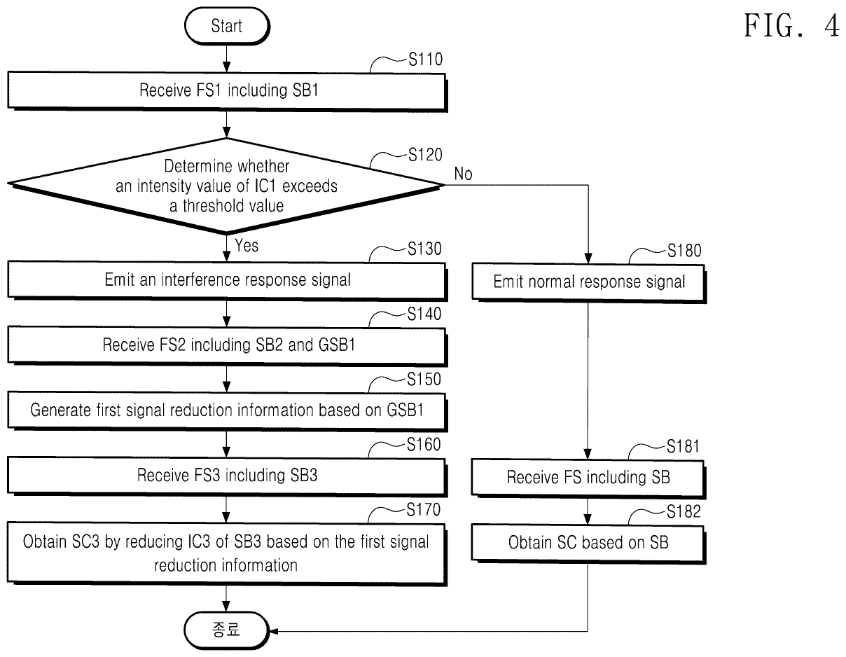

FIG. 4 is a flowchart illustrating an interference component reduction method according to some embodiments of the present disclosure. Referring to FIG. 1 and FIG. 4, a user equipment UE may perform an interference component reduction operation.

In step S110, the user equipment UE may receive a first frame signal FS1 including a first symbol SB1 in which a first interference component IC1 and a first signal component SC1 are mixed. The first interference component IC1 may be generated based on a first surrounding environment SE1.

In step S120, the user equipment UE may determine, based on the first frame signal FS1, whether an intensity value of the first interference component IC1 mixed in the first symbol SB1 exceeds a threshold value.

In step S130, the user equipment UE may emit an interference response signal in response to determining that the intensity value of the first interference component IC1 exceeds a threshold value. The base station BS may emit a second frame signal FS2 based on the interference response signal.

In step S140, the user equipment UE may receive the second frame signal FS2. The second frame signal FS2 may include a second symbol SB2 and a first guided symbol GSB1. The second symbol SB2 may include a second signal component SC2. The first guided symbol GSB1 may include a second interference component IC2. The second interference component IC2 may correspond to the first interference component IC1. In other words, the second interference component IC2 may be based on the first surrounding environment SE1. The first guided symbol GSB1 may be independent of the second signal component SC2.

In step S150, the user equipment UE may generate signal reduction information for reducing the second interference component IC2 based on the first guided symbol GSB1. In other words, the signal reduction information may reduce interference components based on the first surrounding environment SE1. A more detailed description of a method of generating signal reduction information will be described below with reference to FIG. 7.

In step S160, the user equipment UE may receive a third frame signal FS3 including a third symbol SB3 in which a third interference component IC3 and a third signal component SC3 are mixed. The third interference component IC3 may correspond to the first interference component IC1. In other words, the third interference component IC3 may be based on the first surrounding environment SE1.

In step S170, the user equipment UE may obtain the third signal component SC3 by reducing the third interference component IC3 of the third symbol SB3 based on the signal reduction information.

In step S180, the user equipment UE may emit a normal response signal in response to determining that the intensity value of the first interference component IC1 does not exceed the threshold value. The base station BS may emit a frame signal FS based on the normal response signal.

In step S181, the user equipment UE may receive the frame signal FS including a symbol SB in which a signal component SC is mixed.

In step S182, the user equipment UE may obtain the signal component SC included in the symbol SB, based on the symbol SB of the frame signal FS.

By generating signal reduction information based on the guided symbol GSB including the interference component IC and reducing the interference signal included in the symbol SB based on the signal reduction information, a method of efficiently reducing the interference component can be provided.

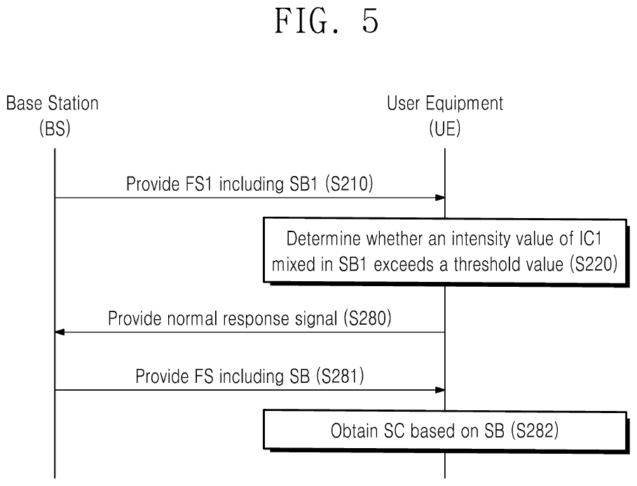

FIG. 5 is a flowchart illustrating a method of operating a base station and a user equipment according to some embodiments of the present disclosure. Referring to FIG. 5, a user equipment UE may communicate with a base station BS.

In step S210, the base station BS may provide a first frame signal FS1 including a first symbol SB1 to the user equipment UE. The first symbol SB1 may be a mixture of a first interference component IC1 and a first signal component SC1. The first interference component IC1 may be generated based on a first surrounding environment.

In step S220, the user equipment UE may determine, based on the first frame signal FS1, whether an intensity value of the first interference component IC1 exceeds a threshold value.

In some embodiments, the base station BS and the user equipment UE may store the same reference symbol. The first frame signal FS1 emitted from the base station BS may include the reference symbol. The base station may provide the first frame signal FS1 to the user equipment UE. In a process in which the first frame signal FS1 is provided to the user equipment UE, an interference component based on the first surrounding environment may be mixed into the reference symbol.

In some embodiments, the user equipment UE may calculate the intensity value of an interference component, based on a comparison operation of the pre-stored reference symbol and the reference symbol in which the interference component is mixed.

In step S280, the user equipment UE may provide a normal response signal to the base station BS in response to determining that the intensity value of the first interference component IC1 does not exceed the threshold value.

In step S281, the base station BS may provide the frame signal FS including the symbol SB to the user equipment UE in response to the normal response signal.

In step S282, the user equipment UE may obtain the signal component SC included in the symbol SB.

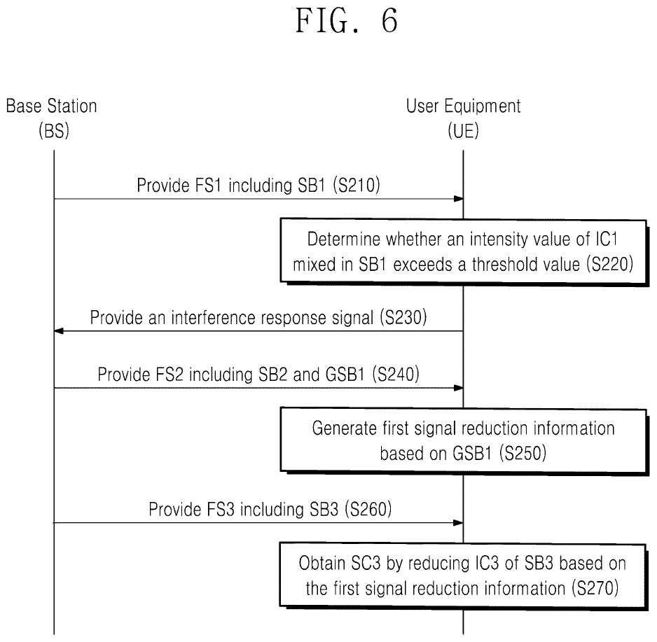

FIG. 6 is a flowchart illustrating a method of operating a base station and a user equipment according to some embodiments of the present disclosure. Referring to FIG. 6, a user equipment UE may communicate with a base station BS.

In step S210, the base station BS may provide a first frame signal FS1 including a first symbol SB1 to the user equipment UE. The first symbol SB1 may be a mixture of a first interference component IC1 and a first signal component SC1. The first interference component IC1 may be generated based on a first surrounding environment.

In step S220, the user equipment UE may determine, based on the first frame signal FS1, whether an intensity value of the first interference component IC1 exceeds a threshold value.

In step S230, the user equipment UE may provide an interference response signal to the base station BS in response to determining that the intensity value of the first interference component IC1 exceeds the threshold value.

In step S240, the base station BS may provide a second frame signal FS2 including a second symbol SB2 including a second signal component SC2 and a first guided symbol GSB1 including a second interference component IC2 to the user equipment UE. The second interference component IC2 may correspond to the first interference component IC1 and may be generated based on the first surrounding environment. The first guided symbol GSB1 may be independent of the second signal component SC2.

In step S250, the user equipment UE may generate first signal reduction information based on the first guided symbol GSB1.

In step S260, the base station BS may provide a third frame signal FS3 including a third symbol SB3 to the user equipment UE. The third symbol SB3 may be a mixture of a third interference component IC3 and a third signal component SC3. The third interference component IC3 corresponds to the first interference component IC1, and may be generated based on the first surrounding environment.

In step S270, the user equipment UE may obtain the third signal component SC3 by reducing the third interference component IC3 of the third symbol SB3 based on the first signal reduction information.

FIG. 7 is a diagram illustrating steps of obtaining signal reduction information according to some embodiments of the present disclosure. Referring to FIGS. 6 and 7, steps S251 to S255 of FIG. 7 may correspond to step S250 of FIG. 6 of generating the first signal reduction information with reference to the first guided symbol GSB1.

In step S251, the user equipment UE may generate interference correlation data in a matrix format based on guided symbol GSB. For example, the interference correlation data may be in a matrix format consisting of N rows and N columns. N may be any natural number.

In step S252, the user equipment UE may generate first to N-th eigenvectors based on the interference correlation data. Further, the user equipment UE may generate first to N-th eigenvalues corresponding to each of the first to Nth eigenvectors.

In operation S253, the user equipment UE may select first to M-th dominant eigenvectors further including the characteristic information of an interference component from among the first to N-th eigenvectors. In addition, the user equipment UE may define eigenvalues corresponding to each of the first to M-th dominant eigenvectors as first to M-th dominant eigenvalues. M may be a natural number less than or equal to N.

In some embodiments, the user equipment UE may generate a Cumulative Distribution Function (CDF) value based on the first to N-th eigenvalues. The CDF value may be a sum of M selected eigenvalues of the first to Nth eigenvalues divided by a sum of the first to the N-th eigenvalues. The user equipment UE may define the M selected eigenvalues as the first to M-th dominant eigenvalues. Further, the user equipment UE may define eigenvectors corresponding to each of the first to M-th dominant eigenvalues as the first to M-th dominant eigenvectors.

In some embodiments, the user equipment UE may select the first to M-th dominant eigenvalues such that the CDF value generated based on the first to N-th eigenvalues and the M eigenvalues selected from the first to Nth eigenvalues exceeds a threshold CDF value.

In step S254, the user equipment UE may generate first to L-th reduction vectors that are all orthogonal to each of the first to M-th dominant eigenvectors.

In step S255, the user equipment UE may generate first signal reduction information based on the first to L-th reduction vectors.

In some embodiments, the first signal reduction information may correspond to a first vector space formed by a linear combination of the first to L-th reduction vectors. The first vector space may be orthogonal to a second vector space formed from a linear combination of the first through M-th dominant eigenvectors.

In some embodiments, the user equipment UE may reduce the interference component IC included in the symbol SB based on the first signal reduction information. For example, the user equipment UE may reduce the interference component IC by projecting the symbol SB onto the first signal reduction information.

In some embodiments, the first signal reduction information may be data in a matrix format generated based on the first to L-th reduction vectors. The symbol SB may be data in a vector format. The user equipment UE may reduce the interference component IC mixed in the symbol SB by projecting the symbol SB in the vector format onto the first signal reduction information in the matrix format.

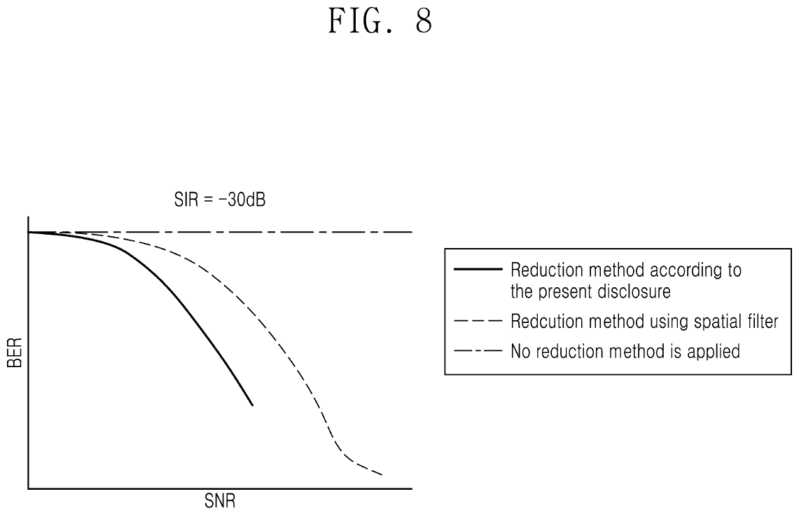

FIG. 8 is a graph illustrating an effect of an interference component reduction method according to some embodiments of the present disclosure. Referring to FIG. 8, the horizontal axis of the graph represents a Signal to Noise Ratio (SNR) value, and the vertical axis represents a Bit Error Rate (BER) value.

The user equipment UE may be provided with a frame signal having a Signal to Interference (SIR) value of −30 dB. Referring to the graph, the correlation between the SNR value and the BER value is shown in the case where the interference component reduction method according to the present disclosure is applied to the received frame signal, in the case where an interference component reduction method using a spatial filter is used, and in the case where no interference component reduction method is applied.

A frame signal to which the reduction method according to the present disclosure is applied may have an SNR value corresponding to the same BER value that is lower than a frame signal to which an interference component reduction method using a spatial filter is used. In other words, since the magnitude of noise corresponding to the same error level is lower when the reduction method according to the present disclosure is applied, an efficient reduction method is provided.

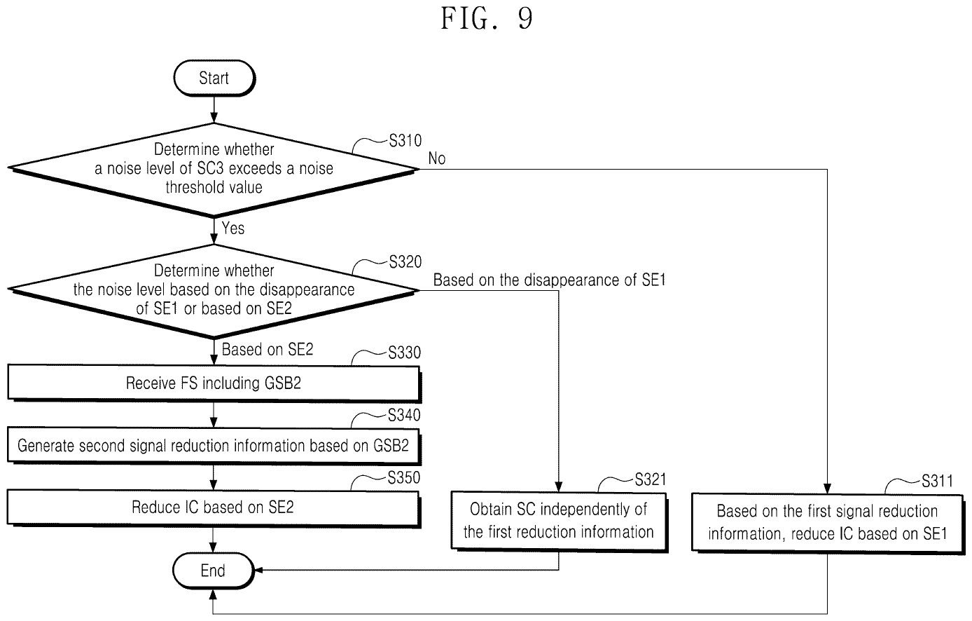

FIG. 9 is a graph illustrating an interference component reduction method according to some embodiments of the present disclosure. Referring to FIGS. 4 and 9, in step S310, the user equipment UE may obtain the third signal component SC3 by reducing the third interference component IC3 of the third symbol SB3.

In step S310, the user equipment UE may determine a noise level of the third signal component SC3, and determine whether the noise level exceeds a noise threshold value.

In step S311, the user equipment UE may receive an additional frame signal FS from the base station BS. In response to determining that the noise level of the third signal component SC3 does not exceed the noise threshold value, based on the first signal reduction information, the user equipment UE may reduce an interference component of the frame signal FS based on the first surrounding environment SE1.

In step S320, in response to determining that the noise level exceeds the noise threshold value, the user equipment UE may determine whether the noise level is based on the second surrounding environment SE2 different from the first surrounding environment SE1 or based on the disappearance of the first surrounding environment SE1.

In step S321, the user equipment UE may receive an additional frame signal FS from the base station BS. In response to determining that the noise level is based on the disappearance of the first surrounding environment SE1, the user equipment UE may obtain the signal component SC from the frame signal FS independently of the first reduction information.

In step S330, in response to determining that the noise level is based on the second surrounding environment SE2, the user equipment UE may receive the frame signal FS including the second guided symbol GSB2 from the base station BS.

In step S340, the user equipment UE may generate second signal reduction information that cancels an interference component IC based on the second surrounding environment SE2, based on the second guided symbol GSB2.

In step S350, the user equipment UE may receive an additional frame signal FS from the base station BS. The user equipment UE may reduce the interference component IC based on the second surrounding environment SE2 in the received frame signal FS, based on the second signal reduction information.

Based on the reduced signal, a change in the surrounding environment SE, which is a cause of generation of the interference component IC, is tracked, and the interference component IC reduction method is changed in response thereto, whereby the interference component can be efficiently reduced.

In some embodiments, a user equipment (UE) may include an interference signal sensing device, an interference signal analysis device, and an interference signal reduction device.

In some embodiments, the interference signal sensing device may receive a first frame signal from a base station, the first frame signal including a first symbol in which a first interference component and a first signal component generated based on a first surrounding environment are mixed, determine whether the intensity value of the first interference component exceeds a threshold value based on the first frame signal, and emit an interference response signal in response to determining that the intensity value of the first interference component exceeds the threshold value.

In some embodiments, the interference signal analysis device may receive, from the base station after emitting the interference response signal, a second frame signal including a second symbol including a second signal component and a first guided symbol independent of the second signal component and including a second interference component corresponding to the first interference component, and generate first signal reduction information that cancels the second interference component based on the first guided symbol.

In some embodiments, the interference signal reduction device may receive, from the base station, a third frame signal including a third symbol in which a third interference component corresponding to the first interference component and a third signal component are mixed, and reduce the third interference component of the third symbol based on the first signal reduction information to obtain the third signal component.

According to an embodiment of the present disclosure, an interference component reduction method using a guided symbol is provided.

Further, there is provided a method of efficiently reducing an interference component by generating signal reduction information based on a guided symbol including an interference component and reducing an interference component included in a frame signal based on the signal reduction information.

The foregoing is specific embodiments for carrying out the present invention. The present invention will include not only the embodiments described above, but also embodiments that can be simply changed in design or easily changed. The invention will also include techniques that can be readily modified and practiced using embodiments. Therefore, the scope of the present invention should not be limited to the above-described embodiments, but should be defined by the following patent claims as well as those equivalent to the patent claims of this invention.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A method of operating a user equipment in communication with a base station, the method comprising:
receiving, from the base station, a first frame signal including a first symbol in which a first interference component generated based on a first surrounding environment and a first signal component are mixed;
determining, based on the first frame signal, whether an intensity value of the first interference component exceeds a threshold value;
emitting, in response to determining that the intensity value of the first interference component exceeds the threshold value, an interference response signal;
receiving, after emitting the interference response signal, a second frame signal from the base station, the second frame signal including a second symbol including a second signal component and a first guided symbol including a second interference component corresponding to the first interference component, wherein the first guided symbol is independent of the second signal component;
generating a first signal reduction information that cancels the second interference component based on the first guided symbol;
receiving, from the base station, a third frame signal including a third symbol in which a third interference component corresponding to the first interference component and a third signal component are mixed; and
obtaining the third signal component by reducing the third interference component of the third symbol based on the first signal reduction information.

2. The method of claim 1, further comprising:
determining a noise level of the third signal component; and
determining whether the noise level exceeds a noise threshold value.

3. The method of claim 2, further comprising:
reducing, in response to determining that the noise level does not exceed the noise threshold value, an interference component based on the first surrounding environment based on the first signal reduction information.

4. The method of claim 2, further comprising:
determining, in response to determining that the noise level exceeds the noise threshold, whether the noise level is based on a second surrounding environment different from the first surrounding environment or based on the disappearance of the first surrounding environment.

5. The method of claim 4, further comprising:
receiving, in response to determining that the noise level is based on the second surrounding environment, a frame signal including a second guided symbol from the base station;
generating, based on the second guided symbol, a second signal reduction information that cancels an interference component based on the second surrounding environment; and
reducing, based on the second signal reduction information, the interference component based on the second surrounding environment.

6. The method of claim 4, further comprising:
obtaining, in response to determining that the noise level is based on the disappearance of the first surrounding environment, a signal component independently of the first signal reduction information.

7. The method of claim 1, wherein the base station and the user equipment store a same reference symbol,
wherein the first frame signal further includes the reference symbol, and
wherein determining, based on the first frame signal, whether the intensity value of the first interference component exceeds the threshold value further comprises:
determining, based on a comparison operation of the first frame signal and the reference symbol stored in the user equipment, the intensity value of the first interference component.

8. The method of claim 1, wherein the second frame signal comprises a subframe signal, and wherein the subframe signal sequentially comprises first to I-th symbols and the first guided symbol.

9. The method of claim 1, wherein generating the first signal reduction information that cancels the second interference component based on the first guided symbol further comprises:
generating, based on the first guided symbol, interference correlation data in a matrix format consisting of N rows and N columns, where N is any natural number;
generating, based on the interference correlation data, first to N-th eigenvectors and first to N-th eigenvalues respectively corresponding to the first to N-th eigenvectors;
determining, based on the first to N-th eigenvectors and the first to N-th eigenvalues, first to M-th dominant eigenvectors further including information of the second interference component and a first to M-th dominant eigenvalues respectively corresponding to the first to M-th dominant eigenvectors, wherein M is any natural number less than or equal to N;
generating first to L-th reduction vectors orthogonal to all of the first to M-th dominant eigenvectors, wherein L is any natural number; and
generating, based on the first to L-th reduction vectors, the first signal reduction information in a matrix data format.

10. A user equipment in communication with a base station, comprising:
an interference signal sensing apparatus configured to receive, from the base station, a first frame signal including a first symbol in which a first interference component generated based on a first surrounding environment and a first signal component are mixed, determine, based on the first frame signal, whether an intensity value of the first interference component exceeds a threshold value, and emit an interference response signal in response to determining that the intensity value of the first interference component exceeds the threshold value;
an interference signal analysis apparatus configured to receive, from the base station after radiating the interference response signal, a second frame signal including a second symbol including a second signal component and a first guided symbol independent of the second signal component and including a second interference component corresponding to the first interference component, and generate first signal reduction information that cancels the second interference component based on the first guided symbol; and
an interference signal reduction apparatus configured to receive, from the base station, a third frame signal including a third symbol in which a third interference component corresponding to the first interference component and a third signal component are mixed, and obtain the third signal component by reducing the third interference component of the third symbol based on the first signal reduction information.

11. The user equipment of claim 10, wherein the interference signal sensing apparatus further configured to determine, based on the third signal component with the third interference component reduced, a noise level of the third signal component.

12. The user equipment of claim 11, wherein the interference signal sensing apparatus further configured to:
determine whether the noise level of the third signal component exceeds a noise threshold value, and
determine, in response to determining that the noise level exceeds the noise threshold value, whether the noise levels are based on a second surrounding environment different from the first surrounding environment or based on the disappearance of the first surrounding environment.

13. The user equipment of claim 12, wherein the interference signal analysis apparatus further configured to:
receive, in response to determining that the noise level is based on the second surrounding environment, a frame signal including a second guided symbol from the base station, and
generate, based on the second guided symbol, second signal reduction information that cancels an interference component based on the second surrounding environment.

14. The user equipment of claim 10, wherein the second frame signal includes a subframe signal, and the subframe signal sequentially includes first to first symbols and the first guided symbol.
